(19) United States
(12) Patent Application Publication
(10) Pub. No.: US 2003/0092804 A1
(43) Pub. Date: May 15, 2003

(54) Crease resistant finishing of cellulose-containing textiles, and laundry post-treatment agents

(76) Inventors: Jurgen Detering, Limburgerhof (DE); Werner Bertleff, Viernheim (DE); Erhard Guenther, Hassloch (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/203,779

(22) PCT Filed: Feb. 14, 2001
(86) PCT No.: PCT/EP01/01607

(30) Foreign Application Priority Data
Feb. 25, 2000 (DE) 10008930.5

(51) Int. Cl. C08L 1/00

(52) U.S. Cl. 524/107

(57) ABSTRACT

Cellulosic textiles are wrinkleproofed by treating them with aqueous dispersions of C₁₄- to C₂₂-alkylketene dimers and drying them. Also disclosed is a laundry aftertreatment composition comprising from 0.1 to 40% by weight of a C₁₄- to C₂₂-alkylketene dimer as aqueous dispersion, from 0.1 to 50% by weight of at least one fabric conditioner and optionally nonionic surfactants.

### DESCRIPTION

This invention relates to a process for wrinkleproofing cellulosic textiles by treating the textiles with a finish and drying the treated textiles and to laundry aftertreatment compositions.

Cellulosic textiles are given easy care properties by treatment with condensation products of urea, glyoxal and formaldehyde, for example. The finish is applied during the manufacture of the textile materials. Softening compounds are frequently further applied with the finish. Thus finished textiles are less wrinkled and creased, easier to iron and softer and smoother after laundering compared with untreated cellulose textiles. But not all cellulosic textiles by a long chalk are given such an easy care finish.

WO-A-92/01773 discloses the use of microemulsified aminosiloxanes in fabric conditioners for reducing wrinkling and creasing during the laundering process. In addition, the use of the amino-siloxanes is said to facilitate the ironing.

WO-A-98/4772 discloses a process for pretreating textile materials by applying a mixture of a polycarboxylic acid and a cationic softener to the textile materials. Wrinkle control is obtained as a result.

EP-A-0 300 525 discloses fabric conditioners based on crosslinked amino-functionalized silicones that impart wrinkle control or an easy-iron effect to textiles treated therewith.

U.S. Pat. No. 5,028,236 discloses using alkylketene dimers to hydrophobicize wool and synthetic polyamide fibers. It is also known to use alkylketene dimers or reaction products of alkylketene dimers with cationic polymers to surface coat fillers, cf. WO-A-92/18695, EP-A-0 451 842 and EP-A-0 445 953. The thusly modified fillers are used for example in papermaking. U.S. Pat. No. 4,241,136 discloses using alkylketene dimers in mixture with a cationic filming polymer to coat glass fibers.

WO-A-96/26318 discloses aqueous dispersions of alkylketene dimers that are used as sizing agents for paper. The alkylketene dimer dispersions contain 1 to 10% by weight of a polymeric protective colloid comprising either a copolymer of N-vinylpyrrolidone and at least one quaternized N-vinylimidazole or comprising condensation products prepared by partial amidation of polyethyleneimines with monocarboxylic acids and subsequent condensation of the partially amidated polyethyleneimines with at least bifunctional crosslinkers. Aqueous dispersions of alkylketene dimers, for example stabilized with cationic starch and optionally containing further dispersing assistants such as ligninsulfonate, are known pulp sizing agents for paper, cf. for example U.S. Pat. No. 4,380,602, U.S. Pat. No. 4,654,386, EP-A-0 369 328, EP-A-0 418 015 or EP-A-0 437 764.

It is an object of the present invention to provide a process for wrinkleproofing cellulosic textiles and a composition for carrying out this process.

We have found that this object is achieved by a process for wrinkleproofing cellulosic textiles by treating the textiles with a finish and drying the treated textiles, which comprises using a finish comprising aqueous dispersions of C₁₄- to C₂₂-alkylketene dimers.

Alkylketene dimers are known. They are chiefly used in the form of aqueous dispersions to pulp size paper. All alkylketene dimer dispersions useful as sizing agents for paper are useful for the process of the invention. Alkylketene dimers are prepared for example from carbonyl chlorides by elimination of hydrogen chloride using tertiary amines. Examples of useful fatty alkylketene dimers are tetradecyldiketene, hexadecyldiketene, octadecyldiketene, eicosyldiketene, docosyldiketene, palmityldiketene, stearyldiketene, oleyldiketene and behenyldiketene. It is also possible to use diketenes having different alkyl groups, eg. stearylpalmityldiketene, behenylstearyldiketene, behenyloleyldiketene or palmitylbehenyldiketene. Preference is given to using stearyldiketene, palmityldiketene, behenyldiketene or mixtures of stearyldiketene and palmityldiketene or mixtures of behenyldiketene and stearyldiketene. The diketenes are included in the aqueous dispersions in concentrations up to 60% by weight for example. Cellulosic textiles are treated using for example dispersions which include from 0.1 to 40% by weight, preferably from 0.5 to 25% by weight, of an alkylketene dimer in dispersed form.

To obtain stable aqueous dispersions of alkylketene dimers, the alkylketene dimers are emulsified in the presence of at least one emulsifier or stabilizer. The best known emulsifier for alkylketene dimers is cationic starch. It is included in the aqueous dispersions of the alkylketene dimers in amounts of from 0.5 to 5% by weight for example. Although all commercially available cationic starches are useful as emulsifiers for alkylketene dimers, it is preferable to use cationic starches which have an amylopectin content of not less than 95%, preferably 98-100%. Such starches are obtainable for example by fractionation of customary native starches or by cultivation of such plants as produce virtually pure amylopectin starch, cf. Günther Tegge, Stärke und Stärkederivate, Behr's Verlag 1984, Hamburg, p. 157 to 160. Amylopectin starch has a branched structure and a high degree of polymerization. The number average molecular weights are for example in the range from 200 million to 400 million. Waxy maize starches having an amylopectin content of 99 to 100% are reported in the literature to have average molar masses (number average) of about 320 million. The degree of cationization of the starch is described using the degree of substitution (D.S.). This value indicates the number of cationic groups per monosaccharide unit in the cationic starch. The DS value of cationic starches is for example in the range from 0.010 to 0.150. In most cases it is below 0.045 in that, for example, most cationic starches have a DS of from 0.020 to 0.040. The preferred starches with amylopectin contents of not less than 95% are waxy maize starch, waxy potato starch, waxy wheat starch and mixtures thereof, in each case in cationized form. For the cationic starches to be effective as emulsifiers, they are customarily converted into a water-soluble form.

To convert the starches into a water-soluble form, they are subjected to an oxidative, enzymatic or hydrolytic degradation process in the presence of acids. Thermal degradation is another possibility, for example by heating aqueous suspensions of starch. The starch is preferably digested in a jet cooker at from 100 to 150° C.

C₁₄- to C₂₂-Alkylketene dimers, for example, are dispersed in the aqueous solutions of the degraded cationic starch at temperatures above 70° C., for example in the range from 70 to 85° C. Alkylketene dimers are present in the form of a melt at these temperatures and are dispersed in the aqueous solution of the cationic starch in homogenizers by the action of high shearing forces. This provides aqueous dispersions of alkylketene dimers that have an average particle diameter of for example from 0.5 to 2.5, preferably from 0.8 to 1.5, μm. The dispersing of the alkylketene dimers in water may if necessary be effected in the additional presence of ligninsulfonic acid, condensation products of formaldehyde and naphthalenesulfonic acid, polymers with styrenesulfonic acid groups or the alkali metal and/or ammonium salts of the sulfo-containing compounds mentioned. These substances act as dispersants and stabilize the resulting alkylketene dimer dispersions. If such dispersants are used to prepare alkylketene dimer dispersions, their amounts range for example from 0.01 to 1%, preferably from 0.02 to 0.2%, by weight, based on the aqueous dispersions. The amount of degraded cationic starch in the aqueous alkylketene dimer dispersions is for example within the range from 0.5 to 5%, preferably from 1 to 3%, by weight.

Alkylketene dimer dispersions may be prepared if necessary in the presence of other customary protective colloids used hitherto in the preparation of alkylketene dimer dispersions, such as water-soluble cellulose ethers, polyacrylamides, polyvinylalcohols, polyvinylpyrrolidones, polyamides, polyamidoamines and also mixtures thereof. Alkylketene dimer dispersions may if necessary include further stabilizing substances, for example C₁- to C₁₀-carboxylic acids, eg. formic acid, acetic acid or propionic acid. The amounts of these ingredients range for example from 0.01 to 1% by weight, based on the-dispersion. Alkylketene dimer dispersions may further include customary biocides, if appropriate.

Particularly advantageously, the aqueous dispersions of alkylketene dimers used as finishes are obtainable by emulsifying alkylketene dimers in the presence of from 1 to 20% by weight, based on alkylketene dimers, of an emulsifier comprising

(a) a copolymer formed from 5-80 mol % of N-vinylpyrrolidone and 95-20 mol % of at least one quaternized N-vinylimidazole and having a K value of not less than 20 (determined by the method of H. Fikentscher in 0.5 m aqueous sodium chloride solution at a polymer concentration of 0.1% by weight and 25° C.) and/or

(b) a condensation product obtainable by partial amidation of polyethyleneimines with monocarboxylic acids and subsequent condensation of the partially amidated polyethyleneimines with at least one bifunctional crosslinker, the condensation products having a viscosity of not less than 100 mPas in 20% by weight aqueous solution at 20° C.

Such aqueous dispersions of alkylketene dimers are known from WO-A-96/26318. Examples of quaternized N-vinylimidazoles useful as comonomers for N-vinylpyrrolidone copolymers are 1-vinylimidazole quaternized with C₁- to C₁₈-alkyl halides, salts of 1-vinylimidazole with mineral acids such as sulfuric acid or hydrochloric acid, 2-methyl-1-vinylimidazole quaternized with C₁- to C₁₈-alkyl halides, 3-methyl-1-vinylimidazolium chloride, 3-benzyl-1-vinylimidazolium chloride, 3-ethyl-1-vinylimidazolium methosulfate and 2-methyl-1-vinylimidazolium methosulfate. The copolymers of N-vinylpyrrolidone may also contain units derived from a plurality of different quaternized N-vinylimidazoles, eg. 1-vinylimidazolium chloride and 2-methyl-1-vinylimidazolium methosulfate. Quaternized N-vinylimidazoles may be characterized for example by means of the following formula:

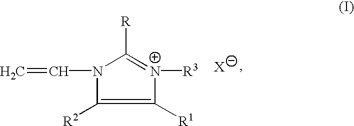

where

R, R¹, R²=H, C₁- to C₄-alkyl or phenyl,

R³=H, C₁- to C₁₈-alkyl or benzyl, and

X⊖ is an anion.

The N-vinylpyrrolidone copolymers preferably contain from 20 to 95% by weight of a quaternized N-vinylimidazole of the formula I in the form of polymerized units. The K value of the copolymers is not less than 20 and is preferably in the range from 40 to 80. The K values of the N-vinylpyrrolidone copolymers are determined by the method of H. Fikentscher in 0.5 m aqueous sodium chloride solution at a polymer concentration of 0.1% by weight and 25° C. Preferred copolymers of N-vinylpyrrolidone contain units derived from vinylimidazole quaternized with methyl chloride or from 2-methyl-1-vinylimidazole quaternized with methyl chloride.

The emulsifier for preparing aqueous dispersions of alkylketene dimers may preferably also be a condensation product obtainable by reacting a partially amidated polyalkylenepolyamine or a partially amidated polyethyleneimine with a crosslinker. Preferred such condensation products for use as emulsifiers are obtainable by a 2-step reaction of polyethyleneimines with C₁- to C₁₈-monocarboxylic acid to form partially amidated polyethyleneimines and subsequent crosslinking of the partially amidated polyethyleneimines. Partially amidated polyethyleneimines may also be prepared for example using alkylketenes, eg. stearyldiketene, palmityldiketene, lauryldiketene, oleyldiketene, behenyldiketene or mixtures thereof. The polyethyleneimines are partially amidated in the first step so that for example from 0.1 to 90%, preferably from 1 to 30%, of the amidable nitrogen atoms in the polyethyleneimines are present as amide group. The amidation will not interlink polyethyleneimine molecules. Such an interlinking takes place only in the course of the subsequent reaction of the partially amidated polyethyleneimines with at least bifunctional crosslinkers. Polyethyleneimines used in the condensation have for example from 10 to 50,000, preferably from 100 to 5000, ethyleneimine units.

Examples of useful crosslinkers for preparing these condensation products are epihalohydrins, especially epichlorohydrin, and also α,ω-bis(chlorohydrin)s of polyalkylene glycol ethers and the α,ω-bis (epoxide)s of polyalkylene glycol ethers that are obtainable from the α,ω-bis(chlorohydrin)s. The chlorohydrin ethers are prepared for example by reacting polyalkylene glycols with epichlorohydrin in a molar ratio of 1 to at least 2 to 5. Examples of useful polyalkylene glycols are polyethylene glycol, polypropylene glycol and polybutylene glycol and also block copolymers of C₂- to C₄-alkylene oxides. The average molar masses M_{w} of the polyalkylene glycols range for example from 200 to 6000, preferably from 300 to 2000, g/mol. Other useful crosslinkers are for example α,ω- or vicinal dichloroalkanes, for example 1,2-dichloroethane, 1,2-dichloropropane, 1,3-dichloropropane, 1,4-dichlorobutane and 1,6-dichlorohexane. Examples of further crosslinkers are the reaction products of at least trihydric alcohols with epichlorohydrin to form reaction products having at least two chlorohydrin units; the polyhydric alcohols used are for example glycerol, ethoxylated or propoxylated glycerols, polyglycerols having 2 to 15 glycerol units in the molecule and also optionally ethoxylated and/or propoxylated polyglycerols. Useful crosslinkers also include compounds containing blocked isocyanate groups, eg. trimethylhexamethylene diisocyanate blocked by 2,2,3,6-tetramethylpiperidin-4-one.

Each part by weight of the partially amidated polyalkylenepolyamines or the partially amidated polyethyleneimines is reacted with from 0.001 to 10, preferably from 0.01 to 3, parts by weight of an at least bifunctional crosslinker. The crosslinking of the partially amidated compounds is carried out at from 0 to 200° C., preferably from 50 to 80° C. The reaction can be carried out in the absence of a solvent, but is preferably carried out in a solvent, in which case the preferred solvent is water. The crosslinking is preferably carried out in the pH range from 10 to 14, typically from 10 to 12. It may be necessary to add a base or a mixture of bases during the condensation reaction. Examples of useful bases for this reaction are sodium hydroxide, potassium hydroxide, calcium oxide, tertiary amines such as triethylamine, triethanolamine or tri-n-propylamine. A preferred base is sodium hydroxide. Particular preference is given to condensation products which are obtainable by partial amidation of polyethyleneimines containing from 10 to 50,000 ethyleneimine units with monocarboxylic acids and condensation of the partially amidated polyethyleneimines with epichlorohydrin, α,ω-bis(chlorohydrin) polyalkylene glycol ethers, α,ω-bis(glycidyl) ethers of polyalkylene glycols, α,ω-dichloropolyalkylene glycols, α,ω- or vicinal dichloroalkanes or mixtures thereof, one part by weight of a partially amidated polyethyleneimine being reacted with from 0.01 to 3 parts by weight of at least one crosslinker. The crosslinked polyethyleneimines, for example as 20% by weight aqueous solution, have a viscosity at 20° C. of at least 100 mPas (measured with a Brookfield RVT viscometer).

The wrinkleproofing finish preferably utilizes such aqueous dispersions of alkylketene dimers as include from 10 to 18% by weight, based on alkylketene dimers, of an emulsifier. Preferred emulsifiers here are the abovementioned copolymers (a) and the condensation products (b).

The aqueous dispersions of alkylketene dimers may additionally include up to 5% by weight, based on alkylketene dimers, of a stabilizer. Preferred stabilizers are ligninsulfonates, quaternary ammonium salts, naphthalenesulfonic acid-formaldehyde condensates, alkyl sulfates, alkylsulfonates, sulfonated polystyrenes, carboxylic acids, sorbitan esters, polycarboxylic acids having molar masses of from 300 to 20 0000, polyvinylsulfonates, polyvinyl alcohols, polyamidosulfonic acids, salts of the acid compounds mentioned or mixtures thereof.

The process of the invention may also be carried out using such aqueous dispersions of alkylketene dimers as are dispersed by means of an anionic emulsifier alone. Examples of useful anionic dispersants are condensation products of naphthalene and formaldehyde, condensation products of phenol, phenolsulfonic acid and formaldehyde, condensation products of naphthalenesulfonic acid, formaldehyde and urea, condensation products of phenol, phenolsulfonic acid, formaldehyde and urea and also homopolymers of monoethylenically unsaturated carboxylic acids, homopolymers of monoethylenically unsaturated sulfonic acids and also copolymers of (i) hydrophobic monoethylenically unsaturated monomers and (ii) monoethylenically unsaturated carboxylic acids, monoethylenically unsaturated sulfonic acids and monoethylenically unsaturated phosphonic acids. The anionic dispersants are used for example in amounts of from 0.05 to 10%, preferably from 0.1 to 5%, by weight, based on alkylketene dimers. The anionic dispersants may be used not only in the form of the free acids but also in the form of the alkali metal, alkaline earth metal and/or ammonium salts. The molar mass M_{w} of the condensation products is preferably in the range from 1000 to 30,000. The homo- and copolymers have for example molar masses M_{w} of from 800 to 250,000, preferably from 1200 to 100,000. Preferred anionic emulsifiers are condensation products of naphthalenesulfonic acid and formaldehyde, homopolymers of acrylic acid and-copolymers of isobutene, diisobutene, styrene or mixtures thereof and acrylic acid or methacrylic acid, maleic acid, monoesters of maleic acid or mixtures thereof and also the water-soluble salts of such polymers. Preferred copolymers contain the comonomers in a molar ratio of 1:1 for their polymerized units.

The present invention also provides for the use of aqueous dispersions of C₁₄- to C₂₂-alkylketene dimers as finishes for wrinkleproofing cellulosic textiles. The aqueous dispersions of alkylketene dimers may be used in various ways. For instance, the textiles may be treated with the finish in connection with their manufacture. Textiles which have not been adequately finished, if at all, may be treated with an aqueous dispersion of alkylketene dimers prior to washing for example. But it is also possible to treat the textiles with an aqueous dispersion of alkylketene dimers after washing. Different formulations are needed in each case. The pretreatment utilizes a textile laundry pretreatment formulation which, as well as a dispersed C₁₄- to C₂₂-alkylketene dimer, includes from 0.1 to 25% by weight, based on the formulation, of a surface-active agent.

A pretreatment is carried out for example by spraying the cellulosic textiles with the aqueous dispersions of alkylketene dimers with an add-on for example from 0.01 to 10% by weight, preferably from 0.1 to 7%, particularly preferably from 0.3 to 4%, by weight, based on the weight of the dry textile material. But the finish may also be applied to the textile material by dipping the textiles into a bath which includes from 0.1 to 10% by weight, preferably from 0.3 to 5% by weight, of an alkylketene dimer in the form of an aqueous dispersion. The textile material is either dipped only briefly into the aqueous dispersion of an alkylketene dimer or else allowed to dwell therein for a period of from 1 to 30 minutes for example.

The textiles which have been treated with an aqueous dispersion of at least one alkylketene dimer, either by spraying or by dipping, are if necessary squeezed off and dried. The drying may take place in air or else in a dryer or else by subjecting the treated textile material to hot ironing. The finish becomes fixed on the textile material in the course of drying. The best conditions in each case are readily ascertainable by experimentation. The temperatures for drying, including ironing, are for example in the range from 40 to 150° C. preferably from 60 to 110° C. For ironing, the cotton program of the iron is suitable in particular. Textiles pretreated with an aqueous dispersion of alkylketene dimers according to the above-described process exhibit an excellent level of wrinkle and crease resistance that is durable to multiple laundering. There is frequently no longer any need to iron the textiles after washing.

The aqueous textile laundry pretreatment formulation comprises for example an aqueous dispersion which includes from 0.1 to 40% by weight, preferably from 0.5 to 25% by weight, of alkylketene dimer in dispersed form and from 1 to 20% by weight, based on alkylketene dimer, of a nonionic, anionic and/or cationic dispersing assistant or stabilizer. In addition, it is also possible for other ingredients such as silicones, preferably amino-containing silicones or silicone surfactants, plasticizers or lubricants such as oxidized polyethylenes or paraffinic waxes and oils or else softening cationic surfactants to be included in the formulation in an amount of up to 25% by weight, based on the formulation. However, this presupposes that there is no incompatibility between the individual components.

A pretreatment formulation to be applied to the textile material by spraying may additionally include a spraying assistant. In some cases, it can also be of advantage to include in the formulation alcohols such as ethanol, isopropanol, ethylene glycol or propylene glycol. Further customary ingredients for a textile laundry pretreatment formulation are scents, dyes, stabilizers, fiber and color protection additives, viscosity modifiers, soil release additives, corrosion control additives, bactericides and preservatives in customary amounts.

When used for aftertreating textiles, the aqueous dispersions of alkylketene dimers are applied in the final rinse cycle following the main wash cycle in a textile laundering process. This treatment can be carried out not only in the course of the manufacture of the textile materials but also in a domestic laundering process. The latter application is preferred. The concentration of the alkylketene dimers in the rinse liquor is for example from 10 to 5000 ppm and is preferably in the range from 50 to 1000 ppm. The rinse liquor may if desired include ingredients typical for a fabric softener or conditioner. Textiles aftertreated in this way and then dried in a tumble dryer likewise exhibit a very high level of crease resistance that is associated with the positive effects on ironing that were described above. The crease resistance can be substantially enhanced by briefly ironing the textiles once after drying. A similar effect is obtained on drying the treated textile material at from 60 to 180° C. during its manufacturing process.

In the above-described finishing variants, the alkylketene dimers are used for example in amounts of from 0.01 to 10% by weight, based on the weight of the textiles. The finishes are preferably added to the final rinse bath in the washing machine in a domestic laundering process. Since the effect of the finish decreases in the course of multiple laundering, the finish is only added to the final rinse bath after the fourth to sixth wash for example, and the original performance level is restored as a result. The finish may also be added to the final rinse bath after every wash or similarly after the second, third, fifth, seventh or tenth wash to thereby restore the finish on the textile to the original level.

The invention also provides a laundry aftertreatment composition comprising

a) from 0.1 to 40% by weight of a C₁₄- to C₂₂-alkylketene dimer as aqueous dispersion

b) from 0.1 to 50% by weight of a fabric conditioner and

c) from 0 to 25% by weight of at least one nonionic surfactant and water ad 100% by weight.

The ingredients of the above-described pretreatment formulation may also be included in the fabric conditioner component of the laundry aftertreatment composition. Fabric conditioners include for example amino-functionalized silicones or other softeners such as cationic surfactants or lubricants. Preferred laundry aftertreatment compositions include for example

a) from 0.1 to 40%, preferably from 1 to 25%, by weight of a C₁₄- to C₂₂-alkylketene dimer as aqueous dispersion,

b) from 0.1 to 40% by weight of at least one cationic surfactant from the group of the quaternary diesterammonium salts, the quaternary tetraalkylammonium salts, the quaternary diamidoammonium salts, the amidoaminoesters and the imidazolinium salts and optionally

(c) up to 50% by weight of at least one nonionic surfactant and water ad 100% by weight.

Useful cationic surfactants, preferably included in the textile laundry aftertreatment formulation in an amount of from 3 to 30% by weight, are for example quaternary diesterammonium salts which have two C₁₁- to C₂₂-alk(en)ylcarbonyloxy(mono- to pentamethylene) radicals and two C₁- to C₃-alkyl or hydroxyalkyl radicals on the quaternary nitrogen atom and, for example, chloride, bromide, methosulfate or sulfate as counterion.

Quaternary diesterammonium salts further include in particular those which have a C₁₁- to C₂₂-alk(en)ylcarbonyloxytrimethylene radical bearing a C₁₁- to C₂₂-alk(en)ylcarbonyloxy radical on the central carbon atom of the trimethylene group and three C₁- to C₃-alkyl or -hydroxyalkyl radicals on the quaternary nitrogen atom and, for example, chloride, bromide, methosulfate or sulfate as counterion.

Quaternary tetraalkylammonium salts are in particular those which have two C₁- to C₆-alkyl radicals and two C₈- to C₂₄-alk(en)yl radicals on the quaternary nitrogen atom and, for example, chloride, bromide, methosulfate or sulfate as counterion.

Quaternary diamidoammonium salts are in particular those which bear two C₈- to C₂₄-alk(en)ylcarbonylaminoethylene radicals, a substituent selected from hydrogen, methyl, ethyl and polyoxyethylene having up to 5 oxyethylene units and as fourth radical a methyl group on the quaternary nitrogen atom and, for example, chloride, bromide, methosulfate or sulfate as counterion.

Amidoamino esters are in particular tertiary amines bearing a C₁₁- to C₂₂-alk(en)ylcarbonylamino(mono- to trimethylene) radical, a C₁₁- to C₂₂-alk(en)ylcarbonyloxy(mono- to trimethylene) radical and a methyl group as substituents on the nitrogen atom.

Imidazolinium salts are in particular those which bear a C₁₄- to C₁₈-alk(en)yl radical in position 2 of the heterocycle, a C₁₄- to C₁₈-alk(en)ylcarbonyl(oxy or amino)ethylene radical on the neutral nitrogen atom and hydrogen, methyl or ethyl on the nitrogen atom carrying the positive charge, while counterions here are for example chloride, bromide, methosulfate or sulfate.

The textile laundry aftertreatment formulation may additionally include customary amounts of customary fabric conditioner additives, for example nonionic surfactants, scents, dyes, stabilizers, fiber and color protection additives, viscosity modifiers, soil release additives, corrosion control additives, bactericides and preservatives.

### EXAMPLES

The percentages in the examples are by weight, unless the context suggests otherwise.

The following finishes were used:

Finish A

1% aqueous dispersion of a C₁₆/C₁₈-alkylketene dimer and cationic waxy maize starch (nitrogen content 0.063%) in a weight ratio of 6:1.5.

Finish B

1% aqueous dispersion of a C₁₆/C₁₈-alkylketene dimer and modified polyethyleneimine in a weight ratio of 6:1. The modified polyethyleneimine was prepared by mixing 258 g of an anhydrous polyethyleneimine which contained 420 ethyleneimine units with 43.7 g of valeric acid and heating the mixture at from 150 to 180° C. for 8 hours during which water was continuously distilled out of the reaction mixture. After cooling, the reaction product was taken up in water and the solids content of the solution adjusted to 25%. 75 g of a 22% of an aqueous solution of bis(chlorohydrin polyethylene oxide with 10 ethylene oxide units were then added and the reaction mixture was heated until the viscosity (measured at 20° C. and a concentration of 21.6%) was 790 mPas.

Finish C

1% aqueous dispersion of a C₁₆/C₁₈-alkylketene dimer and cationic waxy maize starch (nitrogen content 0.33%) in a weight ratio of 6:1.5.

### Examples 1 to 3

Cotton fabrics having the size reported in Table 1 and a basis weight of 160 g/m² were sprayed on both sides with the finishes A, B and C so that the add-on was 2%, based on the respective weight of the dry textile material, and then while slightly moist ironed hot using the cotton program of the iron.

The thusly treated fabric samples and, for comparison, untreated fabric samples of the same size and ballast fabric were washed with a liquid detergent at 40° C. in an automatic domestic washing machine (load in the range from 1.5 to 3.0 kg) and then tumble dried. The washing and tumble drying were carried out five times in succession. A standard washing program and a standard drying program (respectively 40° C. colored wash and the cupboard dry program) were used. After the fifth cycle, the sheetlike fabric samples were visually rated on the lines of the AATCC test method 124, where a rating of 1 indicates that the fabric is highly wrinkled and has many creases and the rating of 5 is awarded to wrinkle- and crease-free fabric. The fabric samples treated with the finishes A, B and C received ratings between 3 and 4. By contrast, the ratings for the untreated fabric samples were between 1 and 1.5, cf. Table 1.

TABLE 1

| | Cotton | Cotton | Cotton |
|---|---|---|---|
| | (40 cm × 40 cm) | (40 cm × 40 cm) | (40 cm × 80 cm) |
| | load 1.5 kg | load 3.0 kg | load 1.5 kg |
| untreated | 1 | 1 | 1 |
| A | 3.5 | 3 | 3 |
| B | 4 | 4 | 4 |
| C | 3.5 | 3 | 3.5 |

The dry crease recovery angle of every fabric sample was determined according to DIN 53890 after five wash cycles. The larger the recovery angle, the greater the effectiveness of the dispersion. The results obtained are reported in Table 2.

TABLE 2

| Cotton (40 cm × 40 cm) | Crease recovery angle |
|---|---|
| load 1.5 kg | Σ (warp and fill) |
| untreated | 104° |
| A | 137° |
| B | 152° |
| C | 143° |

We claim:

1. A process for wrinkleproofing cellulosic textiles by treating the textiles with a finish and drying the treated textiles, which comprises using a finish comprising aqueous dispersions of C₁₄- to C₂₂-alkylketene dimers that are obtainable by emulsifying at least one alkylketene dimer in the presence of a cationic emulsifier.

2. A process as claimed in claim 1, wherein the aqueous dispersions of alkylketene dimers used are obtainable by emulsifying alkylketene dimers in the presence of cationic starch as emulsifier.

3. A process as claimed in claim 1 or 2, wherein the cationic emulsifier used is a cationic starch having an amylopectin content of not less than 95% by weight.

4. A process as claimed in claim 1, wherein the aqueous dispersions of alkylketene dimers used are obtainable by emulsifying alkylketene dimers in the presence of from 1 to 20% by weight, based on alkylketene dimers, of an emulsifier comprising
(a) a copolymer formed from 5-80 mol % of N-vinylpyrrolidone and 95-20 mol % of at least one quaternized N-vinylimidazole and having a K value of not less than 20 (determined by the method of H. Fikentscher in 0.5 m aqueous sodium chloride solution at a polymer concentration of 0.1% by weight and 25° C.) and/or
(b) a condensation product obtainable by partial amidation of polyethyleneimines with monocarboxylic acids and subsequent condensation of the partially amidated polyethyleneimines with at least one bifunctional crosslinker, the condensation products having a viscosity of not less than 100 mPas in 20% by weight aqueous solution at 20° C.

5. A process as claimed in claim 4, wherein the aqueous dispersions of alkylketene dimers include from 10 to 18% by weight, based on alkylketene dimers, of an emulsifier.

6. A process as claimed in any of claims 1 to 5, wherein the aqueous dispersions of the alkylketene dimers additionally include up to 5% by weight, based on alkylketene dimers, of a stabilizer.

7. A process as claimed in claim 6, wherein the stabilizer used is selected from ligninsulfonates, quaternary ammonium salts, naphthalenesulfonic acid-formaldehyde condensates, alkyl sulfates, alkylsulfonates, sulfonated polystyrenes, carboxylic acids, sorbitan esters, polycarboxylic acids having molar masses of from 300 to 20,000, polyvinylsulfonates, polyvinyl alcohols, polyamidosulfonic acids, salts of the acid compounds mentioned or mixtures thereof.

8. The use of aqueous dispersions of C₁₄- to C₂₂-alkylketene dimers that are obtainable by emulsifying at least one alkylketene dimer in the presence of a cationic emulsifier, as finishes for wrinkleproofing cellulosic textiles.

9. A use as claimed in claim 8, wherefor the alkylketene dimers are used in amounts of from 0.1 to 10% by weight, based on the weight of the textiles.

10. A use as claimed in claim 8 or 9, wherefor the finishes are added to the final rinse bath in the washing machine in a domestic laundering process.

11. A laundry aftertreatment composition comprising
a) from 0.1 to 40% by weight of a C₁₄- to C₂₂-alkylketene dimer as aqueous dispersion
b) from 0.1 to 50% by weight of a fabric conditioner and
c) from 0 to 25% by weight of at least one nonionic surfactant and water ad 100% by weight.

12. A laundry aftertreatment composition comprising
(a) from 0.1 to 25% by weight of a C₁₄- to C₂₂-alkylketene dimer as aqueous dispersion,
(b) from 0.1 to 40% by weight of at least one cationic surfactant from the group of the quaternary diesterammonium salts, the quaternary tetraalkylammonium salts, the quaternary diamidoammonium salts, the amidoaminoesters and the imidazolinium salts and optionally
(c) up to 50% by weight of at least one nonionic surfactant and water ad 100% by weight.
